(19) United States
(12) Patent Application Publication
(10) Pub. No.: US 2024/0025706 A1
(43) Pub. Date: Jan. 25, 2024

(54) SYSTEM FOR BOOM AND EXTENSION GEOMETRY DETERMINATION AND REPORTING

(71) Applicant: Delaware Capital Formation, Inc., Wilmington, DE (US)

(72) Inventors: Akshay Raveendran, Kozhikode (IN); Sathish Shivanna, Bangalore (IN); Rushabh Gopani, Mumbai, IN (US); Rajitha Guntupalli, Khammam (IN); KENNETH W. BLAKE, Bristow, OK (US); Haroon A. Khan, Tulsa, OK (US)

(21) Appl. No.: 18/226,098

(22) Filed: Jul. 25, 2023

Related U.S. Application Data
(60) Provisional application No. 63/392,089, filed on Jul. 25, 2022.

(51) Int. Cl. B66C 13/46; B66C 23/36; B66C 13/16

(52) U.S. Cl. CPC B66C 13/46; B66C 23/36; B66C 13/16

(57) ABSTRACT

A first sensor node is fixed to a tool on a derrick truck, and a second sensor node fixed to the derrick truck at a location that does not move when either of the boom and the tool move. The first sensor node measures a position of the tool and a distance between the tool and the first sensor the second sensor node. The measured position of the tool and the distance between the first and second sensor node is reported to a load moment computer.

### CROSS-REFERENCE TO RELATED CASES

This application claims the benefit of U.S. provisional patent application Ser. No. 63/392,089, filed on Jul. 25, 2022, and incorporates such provisional application by reference into this disclosure as if fully set out at this point.

### FIELD OF THE INVENTION

This disclosure relates to heavy machinery in general and, more specifically, to a system for boom extension geometry determination and reporting suitable to a variety of applications.

### BACKGROUND OF THE INVENTION

Operators of heavy equipment such as cranes, or other lifting or moving devices, must remain aware of the effect of a lifted load on the stability of the machine. For example, a lighter load may be safely lifted or moved on an extended boom, but a heavier load may cause an unsafe condition by tending to destabilize or overturn the machine. Additionally, the geometry of a machine is changed as booms are extended, bases rotated, etc. Geometry can also change as a result of loads applied to various mechanical components.

What is needed is a system and method for addressing the above and related problems.

### SUMMARY OF THE INVENTION

The invention of the present disclosure, in one aspect thereof, comprises a system for determining position information on a derrick truck having an extensible boom with a claw mechanism and an auger fitted thereto on a distal end thereof. The system includes a first sensor node affixed to the auger, and a sensor hub that receives data from the at least one sensor node. The at least one sensor node provides data to the sensor hub that includes positional information of the auger. The position information includes an angle of the auger.

In some cases, the angle of the auger includes an angle of the auger with respect to level. The angle of the auger may include an angle of the auger with respect to a part of the derrick truck. The part of the derrick truck may comprise the extensible boom.

The sensor hub may be affixed to a non-extending base of the boom fixed to the derrick truck. The position information may include a distance from the first sensor node to the hub. The hub may comprise a second sensor node.

In some embodiments, the system includes a third sensor node affixed to the boom at a location spaced apart from the base. The third sensor node may report data to the hub including a distance between the third sensor node and the hub and an angle of the boom with respect to the base.

In some embodiments, the claw mechanism has an extended state and a retracted state, and the system further comprises a fourth sensor node affixed to the claw mechanism measuring the angle thereof to determine when the claw mechanism is in the extended state and when the claw mechanism is in the retracted state, and to report the data associated with the determinations to the hub.

The hub may report at least part of the data from the first, second, third, and fourth sensor nodes to a load moment computer on the derrick truck.

The claw mechanism may have an open state and a closed state that are determined by the fourth sensor node.

The first sensor node may be battery powered.

The hub may utilize a fusion of data from the first and second sensor nodes to determine a distance between the first and second sensor nodes.

The invention of the present disclosure, in another aspect thereof, comprise a system for determining position information of a derrick truck comprising. The system comprises a first sensor node fixed to a movable boom mounted to the derrick truck, a second sensor node fixed to the derrick truck at a location that does not move when the boom moves, and a hub gathering measured data from the first and second sensor nodes and determining at least an angle of the boom and a distance between the first and second sensor nodes.

The system may further comprise an auger having a drilling angle that is variable with respect to the boom, and a third sensor node affixed to the auger and reporting the drilling angle of the auger to the hub. The system can include a claw mechanism affixed to the boom and having an extended position, a retracted position, an open state, and a closed state, and a third sensor node affixed to the boom and measuring at least one of the extended position, retracted position, open state and, closed state.

The invention of the present disclosure, in another aspect thereof, comprises a system for determining a moment of a derrick truck with a movable boom and a tool attached thereto. The system includes a first sensor node fixed to the tool, and a second sensor node fixed to the derrick truck at a location that does not move when either of the boom and the tool move. The first sensor node measures a position of the tool and a distance between the tool and the first sensor and the second sensor node. The measured position of the tool and the distance between the first and second sensor node is reported to a load moment computer.

In some cases the position of the tool includes an angle of the tool. The position of the tool may include an open or closed state of the tool.

### BRIEF DESCRIPTION OF THE DRAWINGS

FIG. 1 is a side view of a crane with a load moment indicator according to aspects of the present disclosure.

FIG. 2 is a side view of a cargo truck with articulating crane according to aspects of the present disclosure.

FIG. 3 is an overhead view of the cargo truck of FIG. 2.

FIG. 4 is an exemplary schematic diagram of a node of load moment indicator according to aspects of the present disclosure.

FIG. 5 is a schematic diagram of exemplary topological relationships amongst nodes a load moment indicating system according to aspects of the present disclosure.

FIG. 6 is a flow chart depicting operational flow of a load moment indicator according to aspects of the present disclosure.

FIG. 7 is a relational diagram illustrating sensing and computational operations of various components of a load moment indicator according to aspects of the present disclosure.

FIG. 8 is a side view of a derrick truck according to aspects of the present disclosure.

FIG. 9 is another simplified exemplary schematic diagram of a sensor/node according to aspects of the present disclosure.

### DETAILED DESCRIPTION OF THE PREFERRED EMBODIMENTS

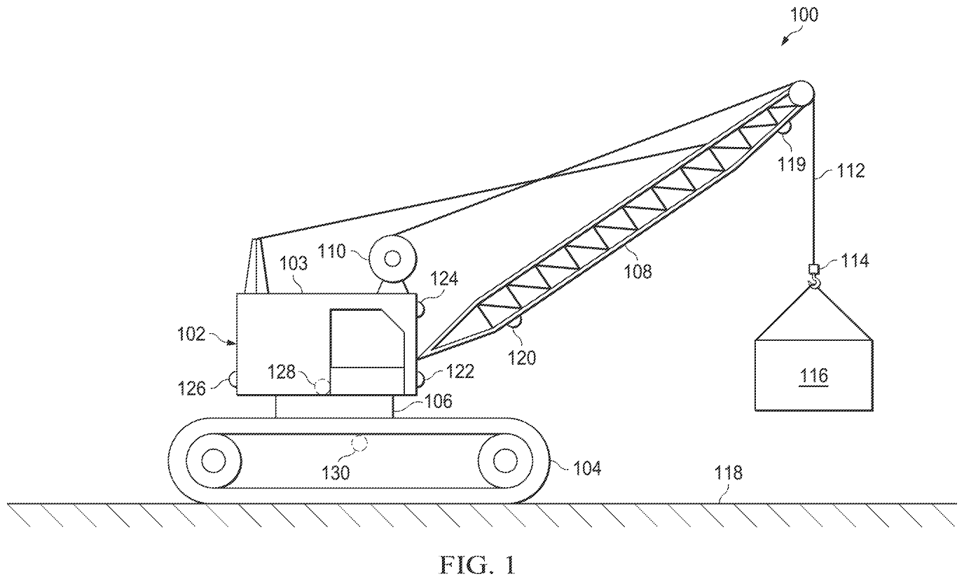

FIG. 1 is a perspective view of a boom crane 100. This represents one type of crane, as is known in the art, with which embodiments of the present disclosure may operate. Other types of cranes or lifting devices may also be used with systems and methods of the present disclosure. These would include, but are not limited to, lattice work cranes, tower cranes, loader cranes, truck mounted cranes and others. Embodiments of the present disclosure may be retrofitted to operate on existing cranes or may be integrated with a crane at the time of manufacture.

The crane 100 comprises an upper portion 102, which may provide a cab 103 and other working components, affixed in a rotational or articulating fashion to a base 104. The base 104 may provide locomotion and gross positioning for lifting, moving, and other work performed by the crane 100. The upper portion 102 may be fixed to the base 104 by a rotational drive mechanism 106. The rotational drive mechanism 106 may also be known as a rotex gear. The rotational drive mechanism 106 may comprise a slew ring and associated powered drive gears and controllers.

The upper portion 102 provides a boom 108 from which loads may be lifted and moved. A single-piece boom 108 is shown but it should be understood that multi-piece booms with jibs and other subcomponents may be utilized. A hoist mechanism 110 or winch spools and unspools winch line 112 for lifting and lowering loads using a load hook 114. The winch line 112 may comprise a woven steel cable or other winch line as is known in the art. The load hook 114 may or may not comprise an actual hook. The load hook 114 serves as a location for securement and release of an associated load 116. Here, the load 116 is shown as a simple box but other loads of varying types are contemplated herein.

In addition to lifting and lowering, the crane 100 also rotates the boom 108 as a component of the upper portion in relation to the base 104. Thus, loads may be lifted and moved based on manipulation or rotation of the rotational drive mechanism 106 and the hoist 110. The base 104 may remain stationary with respect to a work surface 118 when loads are being manipulated. The work surface 118 may be a piece of ground or concrete at a work site, for example. The crane 100 may include various outriggers, counterweights, and additional components as are known in the art.

A load moment indicator (“LMI”) comprises a system to aid an equipment operator by sensing (directly or indirectly) and/or calculating based on various sensors, the overturning or load moment experienced by a piece of operating equipment (e.g., such as the crane 100). In one aspect, the load moment may be considered the load multiplied by the radius or distance of the load weight from the center or center of mass of the crane. Every safely operational lifting machine will have a rated capacity with respect to load moment. An LMI system compares lifting conditions to rated capacity may indicates to the operator a percentage of capacity at which the equipment is working. Lights, bells, or buzzers may be incorporated as a warning of an approaching overload condition.

Fixed or variable data regarding the crane or other machine may be stored in a control computer or LMI computer memory. This may include as information such as dimensional data, capacity charts, boom weights, and centers of gravity. Such data may comprise the reference information used to calculate the operating conditions.

According to the present disclosure, boom length, boom angle, boom elevation and other parameters are measured or calculated based upon data from sensor nodes at various locations on or around the crane 100. Data such as length, position, angle, elevation, rotation and other data, whether measured directly or computed, and relating to the position of a part in space, or with respect to other parts of a lifting machine, or other machine having predefined ranges of relationship between its parts, may be defined as “geometric data”. As the relationship between various parts can change over time (e.g., by movement of a load, boom, etc.) the present position or relationship data may be defined as “current geometric data.”

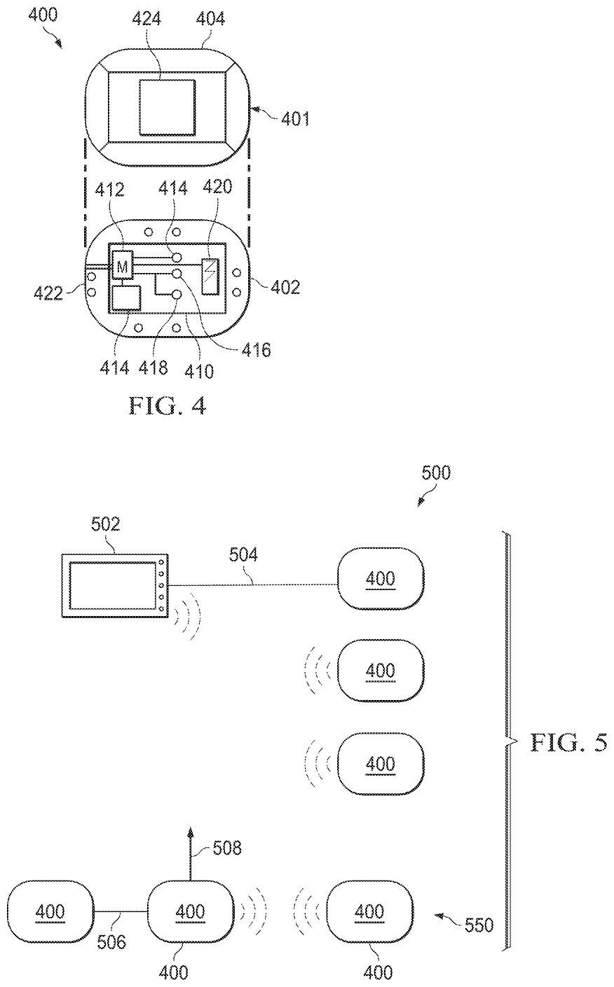

As described further below, various sensor nodes of the present disclosure that may be used to gather or calculate such geometric data may include a plurality of LMI node sensors 400 (FIG. 4). Sensor locations may include locations 118 (ground level), 120 (at or near base of boom 108), 122 (lower portion of cab 102 and/or boom connection point), 124 (top of cab 102 and/or hoist location), 126 (lower, rear of cab 102), 128 (approximate central axis of rotation of the cab 102), 130 (approximate center of mass of unloaded crane 100) or other locations. Additional locations include, but are not limited to a winch or reel, load hook, jib attachments, tracks, chassis, and outriggers. A hydraulic pressure sensor or other device may also provide information with respect to the weight of the load being lifted. In some instances, control computers may be programmed or configured to prevent the operator from moving a load such as to create an unsafe operating condition.

It should be noted that the sensors 118, 120, 122, 124, 126, 128, 130, and/or others, may be utilized to measure deflection and stress on components, apart from changes in geometry resulting from intentional movement of parts (e.g., elevation, rotation, etc.). For example, sensor 120 may measure the angle of the base of boom 108 while an additional sensor midway along the boom, or nearer the boom's distal end (opposite from the cab 102) measures the angle of the boom at an additional location. In a mechanical ideal system, such angles along a rigid and straight boom would be identical. However, in actuality, differences between such angles can be measured as a result of the boom deflection under load, influence of wind, and other factors. Measurement of such information and discrepancies is not limited to deflection of the boom 108 but may be obtained from other components as well based on placement and use of various sensor nodes and bases.

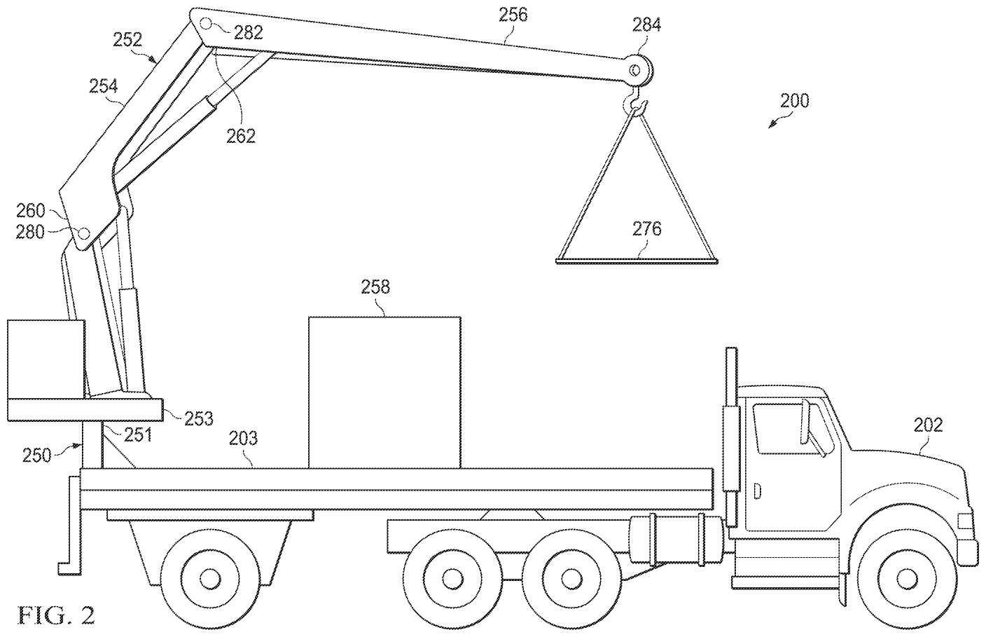

Referring now to FIG. 2, a side view of a cargo truck 200 with articulating crane 250 according to aspects of the present disclosure is shown. Here a truck 200 may include a cab 202 and a cargo bed 203 or the like. The crane 250 may be mounted onto the bed 203, possibly on a stanchion 251 or other support structure. Exact structures of articulating cranes may vary but, as shown, the crane 250 comprises a boom 252 having a plurality of articulating segments 254, 256. The boom 252 may join to a rotatable platform 253 via a joint 260. A joint 262 may connect segments 254, 256. Articulation between the segments 254, 256 and/or the platform 253 may be based on hydraulics and/or electric motors or actuators. In operation, rotation of the platform 253 and movement of the segments 254, 256 about the joints 260, 262 allows loads (e.g., load 258) to be lifted onto or off of the bed 203 from the ground or another surface. An exemplary load platform 276 is shown suspended from a distal end of segment 256, but other attachment devices may be utilized (such as, but not limited to, hooks, clamps, etc.).

As with the crane 100, the crane 200 provides locations at which sensors (e.g., LMI sensor nodes 400, described below) may be placed to measure distances, elevations, angles, etc. for use in LMI calculations. Here sensor location is illustrated at a center of the rotation platform 280 (this also may be where the segment 254 joins the platform 253), a central join location 282, a location 284 on or near a distal end of the far segment 256, and/or a multitude of other locations. Again, additional sensor locations might include the load 258, the ground surface, the load platform 276, multiple locations on the truck (e.g., center of mass), on outriggers, or other important locations.

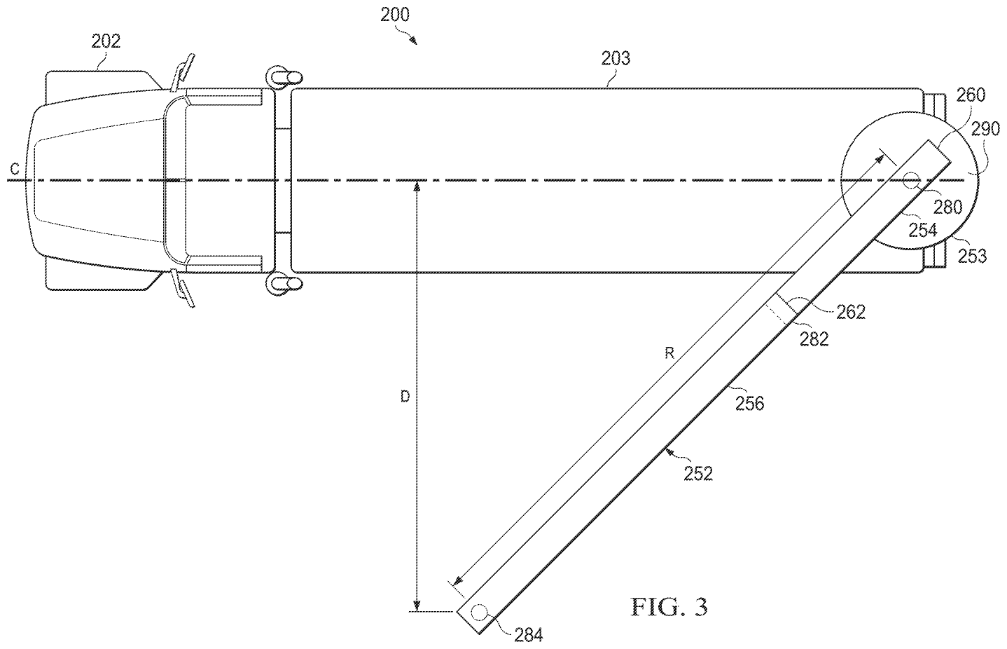

Referring now to FIG. 3, an overhead view of the cargo truck 200 of FIG. 2 is shown. Here, a centerline C of the truck 200 is shown. Load moments may be calculated based off of this line, as shown by distance D, or from a center 290 of rotation of the platform 253 as shown by distance R. In either case, and as with any crane or lifting device there is a maximum distance at which a load of a given weight can be lifted without danger of overturn. As is known in the art, wind, terrain, and other factors may be taken into account as well. It can be critical to accurately gauge the distance from the crane or its center to the load.

It should also be appreciated, from the overhead view of FIG. 3, that the distance between sensor locations 284 and 280 corresponds to the distance R. It is also a simple geometric calculation to determine this distance if the angle of the segments 254, 256 can be measured, and their lengths are known (which they would be on any commercial crane). Similarly, given the distance R, computed or measured, if an angle of rotation of the platform 253 can be calculated or measured, the distance D can be computed as well.

It should be appreciated that similar calculations with respect to load distance can be made based on the sensor locations of FIG. 1. Here if boom 108 length and its angle are known, distance of the load 116 from, for example, the cab at location 122 can be calculated. A distance between sensors locations 122 and 128 can also be used to calculate distance of the load 116 from center of the cab 128. It should also be appreciated that where absolute elevation of, for example, sensors locations 128 and 119 can be determined along with the distance between these sensors, simple trigonometric or geometric calculations enable determination of the distance portion of a load moment calculation (the rest comprising the weight of the load 116). The present disclosure provides systems and methods of sensor nodes and network that enable these kinds of measurements and calculations, and more.

Referring now to FIG. 4 is an exploded diagram of a node 400 of load moment indicator system according to aspects of the present disclosure is shown. The LMI node, or simply “node” 400 of the present disclosure comprises a rugged and robust device capable of installation and operation from any of the various locations previous discussed, and possibly others. In some embodiments, a rugged weatherproof and or waterproof body 401 protects internal components. The body 401 may comprise a metal alloy, a polymer, and elastomer, and/or other materials. The body 401 may comprise a base 402 and cover 403. The base 402 and cover 403 may removably affixed to one another or may be intended to be permanently joined when the node 400 is assembled (e.g., no internal user service ability). Various gaskets, seals, adhesives, fasteners or other implements may be used to join the base 402 and the cover 404. The base 402 or other portion of the body 401 may include various mounting flanges, fasteners, openings, threaded openings or the like to enable the node 400 to be fixed at a chosen location.

Internally, the node 400 may comprise a circuit board 410, or possibly multiple circuit boards joined by buses or other communication pathways if needed. A microcontroller 412 may provide local computing resources for the node 400. The microcontroller 412 may comprise a system-on-a-chip device such that I/O functions, measurement, A/D and D/A conversion, communication, memory and other functions occur on a single chip. The microcontroller 412 may comprise a general purpose or commercially available processor or an application specific integrated circuit (ASIC). In other embodiments, it should be understood that functions of the microcontroller 412 may be split among multiple components. For example, a general-purpose microcontroller may be fitted with stand-alone communication protocol chips, A/D, D/A and other device that, taken together, perform the necessary functions and operations as needed by a microcontroller 412. For simplicity, power leads, pull-up resistors, safety capacitors, and other analog signal conditioning and amplification circuitry is not shown.

One or more sensor 414, 416, 418 may be included for use by or for the node 400. These may feed directly into the microcontroller 412 or may have signal conditioning circuit included. They may also have their own control chips and or routines. Without limitation, the sensors 414, 416, 418 may include accelerometers, rate gyroscopes, magnetometers, barometric pressure sensors, humidity sensors, radio frequency, global positioning system (GPS), RF time of flight or time of arrival (e.g., time difference of arrival, two way ranging), angle (e.g., phased array angle sensing), ultrasonic distance sensors, LIDAR, and vision based ranging such as stereo cameras. Three sensors 414, 416, 418 are shown for illustrative purposes but it should be understood that more or fewer sensors may be present within a node 400. It is also not necessary that every node 400 comprise the same sensor suite. Some sensors are capable of operating entirely enclosed within the cover 401. These would include, for example, angle and gyroscopic sensors. Other sensors may require at least some degree of exposure to the ambient environment. These may include, for example, altitude and pressure sensors, optical sensors, and certain sensors relying on transmission or reception of RF data. In such case, a sensor or sensor probe may be positioned on or within the cover 401 such that such access is provided. It will be appreciated that the cover 401 can be readily adapted to accommodate the sensors within by one of skill in the art.

The node 400 may be powered by an internal power supply 414 or battery. The power supply may be rechargeable by a solar panel 424, for example, by access to on-board vehicle voltage, by inductive means, by known parasitic power access methods, or any other known method. The node 422 may also have an external port 422 that can be used for charging, for data transfer, for programming, and/or other functions. An antenna 420 may be provided internally, as a component of the microprocessor 412 or other component, or externally or within the cover 401.

Referring now to FIG. 5 a schematic diagram of exemplary topological relationships amongst nodes 400 a load moment indicating system 500 according to aspects of the present disclosure is shown. It should be understood that the physical location of the nodes 400 may correspond to the various location on the example cranes (e.g., 100, 250) previously described, or that other physical locations or configurations may be employed. FIG. 5 illustrates possible network topology of the nodes 400. As shown at 500, the nodes 400 may be configured to communicate with a hub 502 via wireline 504 and/or wireless protocols. Wireless protocols may include, but are not limited to, Wi-Fi and Bluetooth®. The number of nodes shown in FIG. 5 is for illustrative purposes only, as there may be more or fewer in any given LMI calculation network.

In one topology, the nodes 400 report to communicate their data to the hub 502. the hub 502 may comprise an LMI computer as is known in the art, or may comprise a hub specifically configured for use with the nodes 400 of the present disclosure. As discussed further below, individual sensor data may be acquired at the nodes 400, although some data may be provided by the hub 502 to further aid the nodes 400 in optimal fusion of data. This data is combined in a sensor fusion algorithm (e.g., by the hub 502 or the nodes 400 themselves) to ultimately resolve local node position. This is communicated back to the hub 502 (if not computed there) and finally to an LMI device or display for use by an operator and/or crane control computer. Thus, it may be appreciated that the hub 502 may itself comprise various computing capacities. The hub 502 may be based on general purpose computer or purpose-built device capable of interacting with the nodes 400 and performing the necessary calculations. One of skill in the art will appreciate the wide variety of ways that the hub 502 may be configured to operate. In some embodiments, the hub 502 provides a display and other I/O implements to enable a user or operator to view data on the hub 502, perform testing, programming and possibly other operations.

In addition to operating with respect to a hub, in some embodiments, the nodes 400 are capable of operating, taking measurements, making calculations, etc., in a hubless arrangement as shown at 550. This type of arrangement may be considered peer-to-peer or ad hoc in operation. Nodes 400 may communicate wirelessly to one another or with a wireline 506. One or more of the nodes 400 in such an arrangement may be able to forward measurements, calculations, or other parameters onward to an LMI computer, display, network, or other device as shown at 508. The communication link 508 may be one-way or two-way and may be a wireless or wireline protocol. It will be appreciated that in order to make certain calculations (e.g., distance or boom angle) it may be necessary that one or more nodes 400 receive data from one or more of the other nodes 400 on the network 550. The receiving node 400 may then implement any needed calculations (for example, those discussed above) using the microcontroller 412, for example.

In further embodiments, a system 500 may have only a single hub 502 and a single node 400. In such embodiments, a single node, such as a node 400 may be positioned somewhere along the length of a boom (such as at location 119, on boom 108, of FIG. 1). In another embodiment, the single node 400 may be placed on a distal location such as location 284 on a component segment such as segment 256. Such embodiment may have full functionality of a node 400 included in the hub 502. Thus, the hub 502 may be placed at a location relative to the single node 400 that accurate measurements (such as distance or others) can be obtained allowing computation of load moments or other parameters.

In some embodiments the hub 502 may be placed at a base location 120 on the boom 108, even if a display of the hub 502 is located elsewhere (such as inside the cab 103). Without limitation, the hub 502 may be located as positions 122, 124, 126, or 130 when used with a single node system, or when used with multiple nodes 400. Similarly, a system such as that shown in FIG. 2 might be configured as a single node system by placing the hub 502 at locations 280, 282, or elsewhere (e.g., inside a cap or on a operator's control panel). One of skill in the art will readily appreciate that a single node system according to the present disclosure may be adapted to wide variety of machinery and work cases without departing form the scope and spirit of the present disclosure.

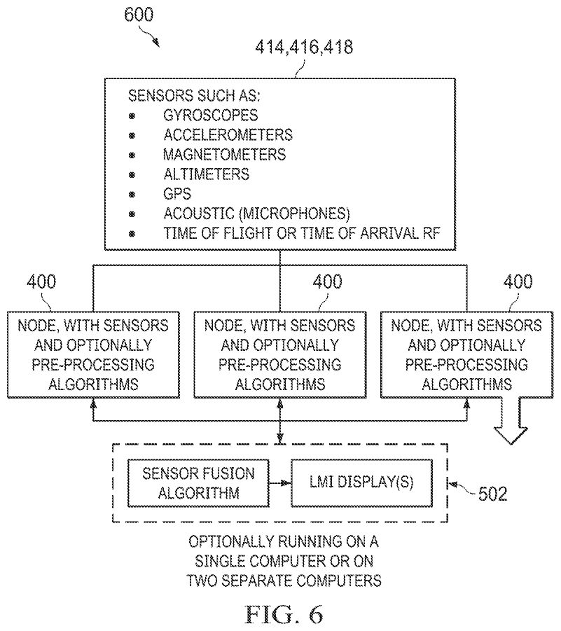

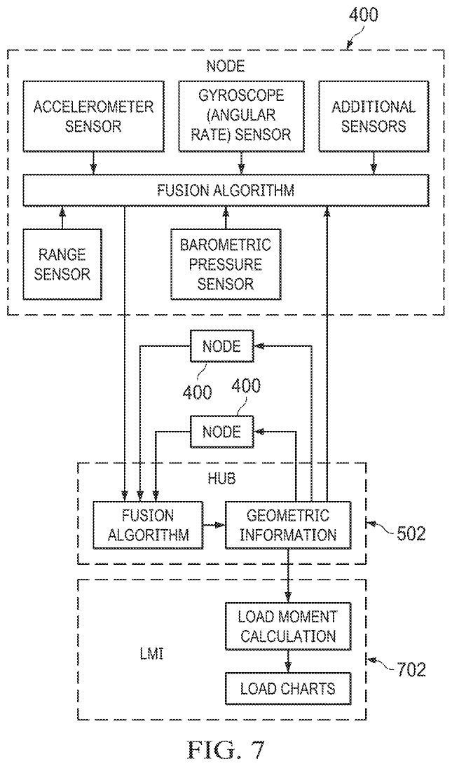

Referring now to FIG. 6, a flow chart depicting operational flow of a load moment indicator according to aspects of the present disclosure is shown. A plurality of separate sensors (e.g., 414, 416, 418, or others) may be arranged in discrete packages or nodes 400. As discussed, multiple sensors 414, 416, 418 may be combined in the same physical discrete package or node 400. Multiple sensor nodes 400 obtaining data pertaining the plurality of sensor locations may be used by an LMI display, computer, or control mechanism 502. Sensor fusion algorithms may be deployed to provide for useful data from the plurality of sensor nodes 400 or locations.

It should be appreciated that systems according to the present disclosure can infer or calculate positions of a variable geometry structure such as a crane 100, 250. The sensor nodes 400 may be distributed or affixed at key positions on the relevant structure or machine. Physical measurements relating to angle, position, relative position (e.g., sensor to sensor) and other information may thus be obtained for various the locations. Although the geometry of the structure that is measured may be variable, it may also be known that it falls within certain parameters. For example, in the crane of FIG. 2, the distance between locations 280 and 282 remains fixed. The distance between locations 280 and 282 also remains fixed. These known distances may not need to be measured but can be used to calculate other data points. Similarly, the position of various locations with respect to the ground (e.g., elevation) may be known for any upright and operational crane or other device. This information can be used to calculate other parameters, possibly using additional measurements from sensor nodes 400. It should be appreciated that when angle measurements are spoken of, these may be angles with respect to a level surface (e.g., ground surface 118), a normal angle (upright), between two components (e.g., segments 254,256) and/or other angles.

Measurements may also be taken with respect to locations that are not affixed to a machine (e.g., crane 100, 250). For example, if a node 400 is affixed to a load (or to a load hook such as 116), it may be possible to determine when an off-center or side lift is about to occur (e.g., due to wind). Thus, the boom 100 may be positioned directly over the load 116 before lifting, which can prevent load shifting. Similarly, given that some relationships between nodes 400 should always fall within specific parameters, if measurements are obtained that are beyond the parameters, it may be an indication of a fault in the LMI nodes 400, the hub 502, or in the crane or other machine itself. For example, the angle between segments 254, 256 of the boom 252 may indicate a broken or fatigued component such that the crane 250 or truck 200 needs repair or service.

Referring now to FIG. 7 a relational diagram 700 illustrating sensing and computational operations of various components of a load moment indicator according to aspects of the present disclosure is shown. FIG. 7 illustrates a number of nodes 400, each of which may be capable of collating and fusing data from multiple sensors to establish information with respect to position, angle, etc. This may occur on the microprocessor 412. Data may be transmitted to the hub 502, which may also perform fusion algorithms. Geometric information may be transmitted to the nodes 400 in combination with fusion data back to the nodes 400 as needed. Finally, the final geometric information with respect to load moments may be transmitted to an LMI system 702 for calculation and/or comparison against load charts (electronic or digital) to ensure the crane or other machine is not operated outside of safe parameters.

Various fusion algorithms may be used to establish final positions for sensors/locations, especially where readings are not entirely stable, or where there is conflict between readings or calculations based on those readings. Without limitation, such methods and algorithms include Kalman, extended Kalman, unscented Kalman (a type established sensor fusion algorithm, the internal coefficients and parameters are unique to each filter), and complementary filter. Relationships between sensor readings (such as gyro and accelerometer readings) can be used to smooth angle sensing and to calculate radius (for example) by the ratio of their readings. These relationships may be coded into the matrices of a Kalman filter, for example. The geometric constraints of the physical platform (in this case a crane) provides an extra degree of precision.

For non-directly measured parameters, redundant sensors may be used to better calculate the true value of the parameter. Additional nodes 400 can be placed on attachments (or even placed on the load or hand carried) to aid in correct configuration detection or localization. Additional parameters can be measured indirectly, such as parts of line (number of loops of the lifting rope through the hook pulley block), outrigger location, load position in relation to the boom tip or hook etc., but various nodes 400 of the present disclosure, or other known sensor types.

Sensor fusion may enable information to be assembled, collated, or otherwise used to determine attributes across the entire machine, or related to only relevant portions of the machine (e.g., cranes 100, 250 or other machines). Positions may be reported to control and/or LMI computers. In some specific embodiments, boom angle and position information may be utilized by the LMI and compared against stored or computed values relating to safe lift or movement of loads. This information may be used by control computers or provided as data to an operator. Unsafe load conditions may provide audible, visual, or tactile warnings to the operator. In some embodiments, control computers will prevent or halt unsafe movements based on the LMI systems and methods herein described.

In some embodiments, nodes or bases of systems according to the present disclosure may obtain, measure, record, or compute data for sharing with another system. According to various embodiments, such data may be shared on a common bus such as a CANBUS. Other digital communication protocols can be implemented as well. In some embodiments, communication via analog signals (e.g., voltage levels) is implemented.

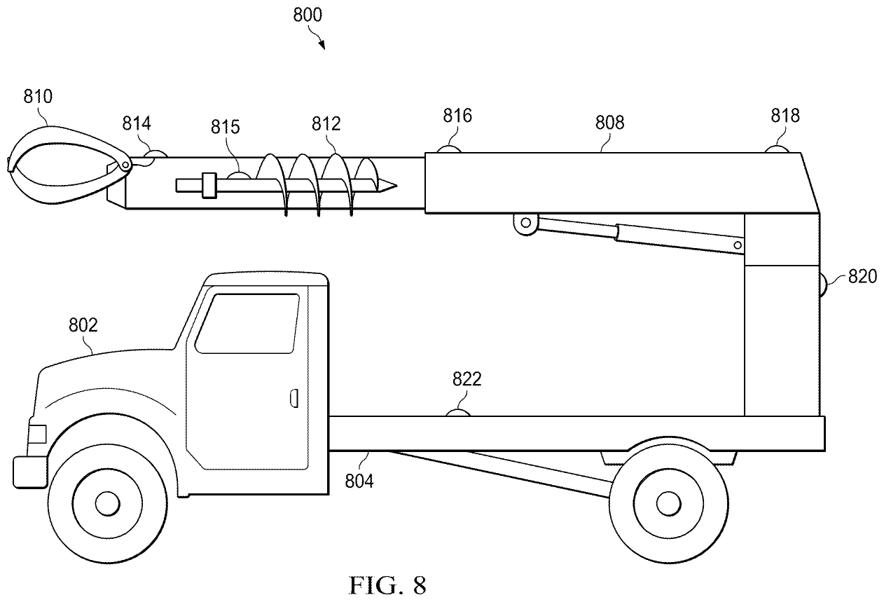

Referring now to FIG. 8 is a side view of a derrick truck according to aspects of the present disclosure is shown. In addition to use on cranes and truck mounted cranes, systems of the present disclosure may be deployed on derrick trucks (e.g., 800) and the like. A derrick truck may comprise a truck cab 802 with a platform or bed 804 to the rear. Mounted on the rear platform 804 is a boom 808 that may be adjustable for elevation, rotated, extended, or perform other movement under hydraulic and/or electric power.

Various tools and implements may be available to the operator and associated with or mounted to the boom 808. For example, a claw mechanism 810 may be used to grasp and manipulate utility pole or other objects to be moved. An auger or drill 812 may also be provided. Buckets, platforms and other devices or tools may be affixed to or otherwise associated with the boom 808.

Systems of the present disclosure may utilize sensor nodes or bases at various locations to obtain geometric and other data about the system 800. For example, a sensor node 814 may be placed on or near the claw mechanism 810. Node 814 may be used to obtain and report such information as claw angle, extension, retraction, and closure status (e.g., open or closed). Some commercial claw devices can report whether they are currently grasping a load or unloaded. Such information may be obtained by the node 814 whether or not it gathers its own related data as well. In some embodiments, different or additional auxiliary data may be obtained by one of more sensor nodes/bases for use by systems according to the present disclosure.

The auger or drill 812 may also have one or more sensor nodes such as node 815 affixed thereto measure the angle and/or deflection of the auger 812. It should be understood that the auger 812 may rotate, but such rotational angle of the bit is separate from the angle in which the auger 812 is pointing or its drilling angle (for example, as illustrated, the angle of the auger matches the angle of the boom 808 whether measured relative to the ground, the platform 804, the base 820, or another location or component). The auger 812 may be hydraulic, electrical, or powered by another source. The auger 812 may have rotating and non-rotating portions. In some embodiment, the sensor 815 is affixed to a non-rotating portion of the auger 812 to measure the drilling angle or deflection as opposed to a rotational angle of the bit.

As with previous embodiments, the boom 808 may be measured and reported upon based on a number of sensors including sensor nodes 814, 816, and 818 ranging from distal to proximal on the boom 808. Another node 820 (or a sensor base) may be placed on an upright support of the boom and/or on the platform 804 (e.g., sensor node/base 822) to provide additional information relating to loading, movement, deflection, and other geometric data.

Similar to previous embodiments, the sensor nodes 814, 815, 818, 820, 822 of system 800 may measure angles, elevations, distances between various sensors, and other information based upon the sensors contained therewith. Given that the geometry of the system 800 is restrained by the reachable angles, rotation, and extension of the boom 808, the angle of the auger 812, and the extension or retraction of the claw mechanism 810, measurement of angles and distances between sensors 814, 815, 818, 820, 822 of the system 800 allows moment to be calculated by one or more of the sensor nodes or elsewhere. Additionally, one of the sensor nodes 814, 815, 818, 820, 822 or another sensor node can also act as a hub and perform calculations based on data from all the other sensor nodes. Hubs or sensors may also make calculations based on sensor fusion as in other embodiments.

It should be understood that sensor nodes or bases, but particularly nodes, according to various embodiments may be deployed in areas or on machine locations that are difficult to wire or retrofit to provide electrical power. Wiring on a boom, for example, may be subject to being damaged or shorn by moving loads, trees, weather events, and other environmental hazards. Therefore, according to some embodiments, at least some of the sensors/nodes are powered by battery technology.

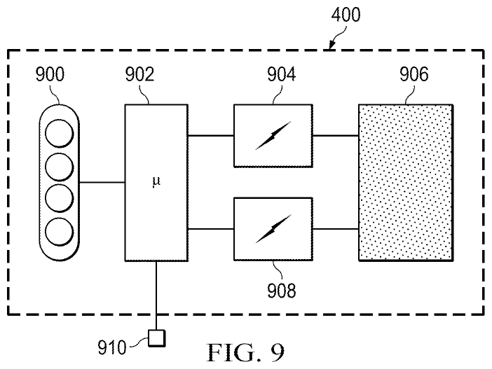

Referring now to FIG. 9, another simplified exemplary schematic diagram of a sensor node/base 400 according to aspects of the present disclosure is shown. It should be understood that, in various embodiments, the relation between a sensor node and a base may be one of topology rather than a distinction between hardware configurations. Thus, the sensor node 400 is herein also designated a base. It should also be understood that the diagram of FIG. 9 is not intended to supersede the diagram of FIG. 7, but rather augment it.

The node/base 400 may comprise a sensor bank 900 and/or one or more individual sensors. These may be any type of sensor discussed herein, or others. A microcontroller 902 may obtain data from the sensor bank 900 and/or from individual sensors or sources beyond the node/base 400. The microcontroller 902 may be powered by a rechargeable battery 904, which may comprise a lithium-based battery or cell. A solar panel 906 may be integrated into the node/base 400 enclosure, or otherwise attached or connected thereto. Temperature may be monitored specifically for the battery 904 to ensure it is operating within acceptable parameters.

A secondary battery 908, with may be lithium-based or based on other chemistry, may be employed if/when the primary battery 904 becomes inoperative (e.g., by discharge, or damage). The secondary battery 908 may extend runtime where there is low solar radiation, for example, and/or the primary battery 904 cannot be satisfactorily operated. An external battery may be provided and connected to the node/base by external battery connection 910. Thus, the components of the system of the present disclosure can be operated for an extended period of time in a wide variety of conditions.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)−(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7−91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A system for determining position information on a derrick truck having an extensible boom with a claw mechanism and an auger fitted thereto on a distal end thereof, the system comprising:
a first sensor node affixed to the auger;
a sensor hub that receives data from the at least one sensor node;
wherein the at least one sensor node provides data to the sensor hub that includes positional information of the auger;
wherein the position information includes an angle of the auger.

2. The system of claim 1, wherein the angle of the auger includes an angle of the auger with respect to level.

3. The system of claim 1, wherein the angle of the auger includes an angle of the auger with respect to a part of the derrick truck.

4. The system of claim 3, wherein the part of the derrick truck comprises the extensible boom.

5. The system of claim 3, wherein the sensor hub is affixed to a non-extending base of the boom fixed to the derrick truck.

6. The system of claim 5, wherein the position information includes a distance from the first sensor node to the hub.

7. The system of claim 6, wherein the hub comprises a second sensor node.

8. The system of claim 7, further comprising a third sensor node affixed to the boom at a location spaced apart from the base.

9. The system of claim 8, where the third sensor node reports data to the hub including a distance between the third sensor node and the hub and an angle of the boom with respect to the base.

10. The system of claim 9, wherein the claw mechanism has an extended state and a retracted state, and further comprising a fourth sensor node affixed to the claw mechanism measuring the angle thereof to determine when the claw mechanism is in the extended state and when the claw mechanism is in the retracted state, and to report the data associated with the determinations to the hub.

11. The system of claim 10, wherein the hub reports at least part of the data from the first, second, third, and fourth sensor nodes to a load moment computer on the derrick truck.

12. The system of claim 10, wherein the claw mechanism has an open state and a closed state that are determined by the fourth sensor node.

13. The system of claim 5, wherein the first sensor node is battery powered.

14. The system of claim 7, wherein the hub uses a fusion of data from the first and second sensor nodes to determine a distance between the first and second sensor nodes.

15. A system for determining position information of a derrick truck comprising:
a first sensor node fixed to a movable boom mounted to the derrick truck;
a second sensor node fixed to the derrick truck at a location that does not move when the boom moves; and
a hub gathering measured data from the first and second sensor nodes and determining at least an angle of the boom and a distance between the first and second sensor nodes.

16. The system of claim 15, further comprising:
an auger having a drilling angle that is variable with respect to the boom; and
a third sensor node affixed to the auger and reporting the drilling angle of the auger to the hub.

17. The system of claim 15, further comprising:
a claw mechanism affixed to the boom and having an extended position, a retracted position, an open state, and a closed state; and
a third sensor node affixed to the boom and measuring at least one of the extended position, retracted position, open state and, closed state.

18. A system for determining a moment of a derrick truck with a movable boom and a tool attached thereto, the system comprising:
a first sensor node fixed to the tool;
a second sensor node fixed to the derrick truck at a location that does not move when either of the boom and the tool move; and
wherein the first sensor node measures a position of the tool and a distance between the tool and the first sensor the second sensor node;
wherein the measured position of the tool and the distance between the first and second sensor node is reported to a load moment computer by one of the first and second sensor nodes.

19. The system of claim 18, wherein the position of the tool includes an angle of the tool.

20. The system of claim 19, where the position of the tool includes an open or closed state of the tool.
